(19) United States
(12) Patent Application Publication
(10) Pub. No.: US 2015/0210513 A1
(43) Pub. Date: Jul. 30, 2015

(54) SECURING DEVICE FOR A CRANE

(71) Applicant: Palfinger AG, Salzburg (AT)

(72) Inventors: Clemens MAYR, Neumarkt am Wallersee (AT); Richard REISCHAUER, Schalchen (AT); Walter HABERL, Nussdorf (AT)

(21) Appl. No.: 14/683,510

(22) Filed: Apr. 10, 2015

Related U.S. Application Data
(63) Continuation of application No. PCT/AT2013/000175, filed on Oct. 17, 2013.

(30) Foreign Application Priority Data
Oct. 19, 2012 (AT) 407/2012

(51) Int. Cl. B66C 13/18; B66C 23/50; B66C 23/78; B66C 23/90; B60P 1/54; B60S 9/04

(52) U.S. Cl. CPC B66C 13/18; B60P 1/5433; B60S 9/04; B66C 23/78; B66C 23/90; B66C 23/50

(57) ABSTRACT

The invention relates to a method for securing the position of a crane with at least two support legs for supporting said crane on surfaces. At least one threshold is entered for the support legs, and movements which increase the supporting force are blocked if at least one threshold is exceeded by a current supporting force, the thresholds for each of the support legs being entered individually and/or for subgroups of support legs.

The present invention concerns a method of securing a position of a crane having the features of the classifying portion of claim 1, a safety device for a crane having the features of the classifying portion of claim 2 and a crane having such a safety device.

Methods of the general kind set forth provide for the input of a limit value for the supporting forces occurring at the support legs of the crane, and further movements of the crane, that increase those supporting forces, are blocked when the instantaneous supporting force is exceeded at one of the support legs. In particular that not only involves crane movements which increase the tilting moment or the load moment, but also pivotal movements which increase the loading on a support.

A disadvantage in that respect is that the input limit value applies simultaneously to all supports. In the case of a varying terrain that can lead to a decreased area of use of the crane, for example because one of the supports of the crane is supported on a surface which is of very low strength, and the limit value has to be selected for that low level of strength. A situation which can serve as an example is one in which all except for one of the support legs of a crane are supported on an asphalted road and the last one is supported on softer ground or a manhole cover.

The object of the invention is to provide a method which enlarges the area of use of the crane in such a situation.

That object is attained by a method having the features of claim 1, a safety device having the features of claim 2 and a crane having the features of claim 6.

That is effected in that the limit values for the instantaneous supporting forces at the support legs can be input individually or for subgroups of the support legs and can be stored in the safety device.

Further advantageous embodiments of the invention are defined in the appendant claims.

In an embodiment of the invention it can be provided that the support legs are in the form of hydraulic supports with a hydraulic cylinder. In that case it can be provided that force measurement is implemented by strain gauges at the support legs or is in the form of a pressure measuring device in the hydraulic cylinders.

Such a safety device can be used for example in a crane which is mounted on a vehicle. In that case the vehicle for example can be a truck or a rail vehicle.

Further advantages and details of the invention will be apparent from the Figures and the related specific description. In the Figures:

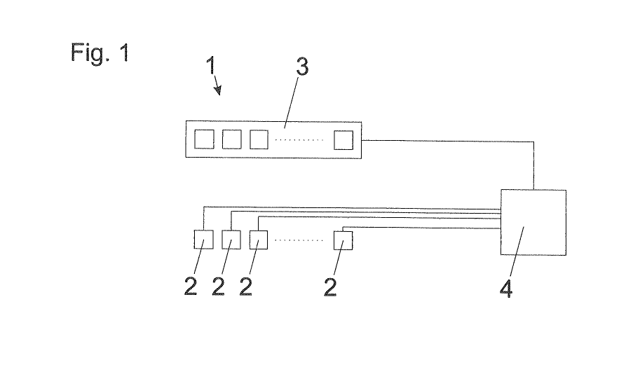

FIG. 1 shows a block diagram of a safety device according to the invention, and

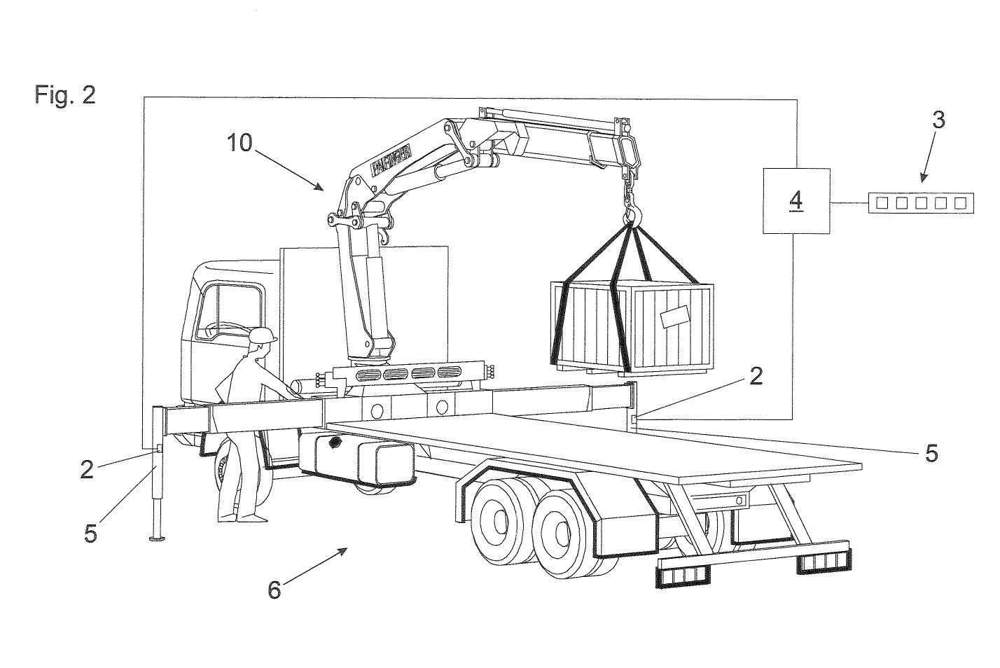

FIG. 2 shows a perspective view of a crane with a safety device according to the invention, the crane being mounted on a vehicle.

FIG. 1 shows a block diagram of a safety device 1 according to the invention. Here the control device 4 is connected on the one hand to the force measuring devices 2. On the other hand it is connected to the input device 3 at which the limit values for the support legs can be individually set.

FIG. 2 shows a crane 10 which is mounted on a vehicle 6 and has two supports 5. The force measuring devices 2 as well as the control unit 4 and the input device 3 are also symbolically shown. The connection of the force measuring devices 2 to the control device 4 does not have to be cabled but can also be implemented for example by radio.

1. A method of securing a position of a crane having at least two support legs for support on surfaces, in which at least one limit value is input for the support legs, wherein when at least one limit value is exceeded by an instantaneous supporting force movements which increase the supporting force are blocked, wherein the limit values for each of the support legs are input individually and/or for subgroups of support legs.

2. A safety device for a crane having
at least two support legs for support on surfaces,
force measuring devices for determining the instantaneous supporting forces which act at the support legs,
an input device for the input of at least one limit value for the support legs, and
a control device which is connected to the force measuring devices and to the input device and which when at least one limit value is exceeded by the respective instantaneous supporting force movements of the crane which increase the respective supporting force are blocked,
wherein the limit values can be input individually for each support leg and/or for subgroups of support legs and can be stored in the control device.

3. A safety device as set forth in claim 2 wherein the support legs are in the form of hydraulic supports with a hydraulic cylinder.

4. A safety device as set forth in claim 2 wherein the force measuring devices are in the form of strain gauges at the support legs.

5. A safety device as set forth in claim 2 wherein the force measuring devices are in the form of pressure measuring devices in the hydraulic cylinders.

6. A crane having a safety device as set forth in claim 2.

7. A vehicle having a crane as set forth in claim 6.

8. A vehicle as set forth in claim 7 wherein the vehicle is in the form of a truck.

9. A vehicle as set forth in claim 7 wherein the vehicle is in the form of a rail vehicle.
